(19) United States
(12) Patent Application Publication
(10) Pub. No.: US 2021/0097438 A1
(43) Pub. Date: Apr. 1, 2021

(54) ANOMALY DETECTION DEVICE, ANOMALY DETECTION METHOD, AND ANOMALY DETECTION PROGRAM

(71) Applicant: KABUSHIKI KAISHA TOSHIBA, Tokyo (JP)

(72) Inventors: Mari MATSUMOTO, Kawasaki (JP); Masanori FURUTA, Odawara (JP)

(73) Assignee: KABUSHIKI KAISHA TOSHIBA, Tokyo (JP)

(21) Appl. No.: 17/014,270

(22) Filed: Sep. 8, 2020

(30) Foreign Application Priority Data
Oct. 1, 2019 (JP) 2019-181373

(51) Int. Cl. G06N 20/00; G06N 3/04; G06K 9/62; G06N 7/00; G16Y 40/10

(52) U.S. Cl. CPC G06N 20/00; G06N 3/0445; G16Y 40/10; G06N 7/005; G06K 9/6215

(57) ABSTRACT

According to one embodiment, an anomaly detection device includes predicted value calculation unit, an anomaly degree calculation unit, a second predicted value calculation unit, a determination value calculation unit, and an anomaly determination unit. The first predicted value calculation unit calculates a first model predicted value from a correlation model obtained by first machine learning, the anomaly degree calculation unit calculates an anomaly degree, the second predicted value calculation unit calculates a second model predicted value from a time series model obtained by second machine learning, the determination value calculation unit calculates a divergence degree, and the anomaly determination unit determines whether an anomaly occurs or not.

### CROSS-REFERENCE TO RELATED APPLICATIONS

This application is based upon and claims the benefit of priority from Japanese Patent Application No. 2019-181373, filed Oct. 1, 2019, the entire contents of which are incorporated herein by reference.

### FIELD

Embodiments described herein relate generally to an anomaly detection device, an anomaly detection method, and an anomaly detection program.

### BACKGROUND

An anomaly detection technique of detecting a failure sign by monitoring values of sensors provided on mechanical equipment of a vehicle or the like (hereinafter referred to as sensor values) to notify the sign before occurrence of the failure is known.

To detect failure signs from a plurality of sensor information according to the anomaly detection technique, a method of executing machine learning using a plurality of sensor values acquired at the same time and executing evaluation based on a degree of deviation between values of correlation models obtained by learning and the acquired sensor values is employed.

However, the process amount of the degree of deviation which is the evaluation index increases according to the number of sensors used for evaluation.

In particular, recently, when a lot of Internet of Thing (IoT) devices are connected on the Internet and the IoT devices are used as information sources (corresponding to sensors) in the anomaly detection technology, an anomaly detection technology for efficiently processing a large amount of sensor values is desired.

In addition, when the anomaly detection technology is used as a security measure on the information network, data (corresponding to the sensor value) included in access logs and the like include are used, and a number of types of data should desirably be processed efficiently.

### BRIEF DESCRIPTION OF THE DRAWINGS

FIG. 1 is a functional block diagram showing an example of a network configuration according to a first embodiment.

FIG. 2 is a functional block diagram showing an example of a functional configuration of an anomaly detection unit according to the embodiment.

FIG. 3A is a diagram showing an example of machine learning in a first learning unit according to the embodiment.

FIG. 3B is a diagram showing an example of machine learning in a second learning unit according to the embodiment.

FIG. 4A is a flowchart showing an example of a process operation at generation of first and second models of the anomaly detection unit according to the embodiment.

FIG. 4B is a flowchart showing an example of a detailed process operation at generation of the first model of the anomaly detection unit according to the embodiment.

FIG. 4C is a flowchart showing an example of a detailed process operation at generation of the second model of the anomaly detection unit according to the embodiment.

FIG. 5 is a graph showing an example of a threshold determination method in a threshold determination unit according to the embodiment.

FIG. 6 is a flowchart showing an example of a process operation at use of the anomaly detection unit according to the embodiment.

FIG. 7 is a functional block diagram showing an example of a configuration of an anomaly detection system according to a second embodiment.

FIG. 8 is a functional block diagram showing an example of a functional configuration of a detected device according to the embodiment.

FIG. 9 is a functional block diagram showing an example of a network configuration according to a third embodiment.

FIG. 10 is a functional block diagram showing an example of a network configuration according to the embodiment.

### DETAILED DESCRIPTION

Embodiments will be described hereinafter with reference to the accompanying drawings.

In general, according to one embodiment, an anomaly detection device includes predicted value calculation unit, an anomaly degree calculation unit, a second predicted value calculation unit, a determination value calculation unit, and an anomaly determination unit.

The first predicted value calculation unit calculates a first model predicted value from a correlation model obtained by first machine learning, the anomaly degree calculation unit calculates an anomaly degree, the second predicted value calculation unit calculates a second model predicted value from a time series model obtained by second machine learning, the determination value calculation unit calculates a divergence degree, and the anomaly determination unit determines whether an anomaly occurs or not.

### First Embodiment

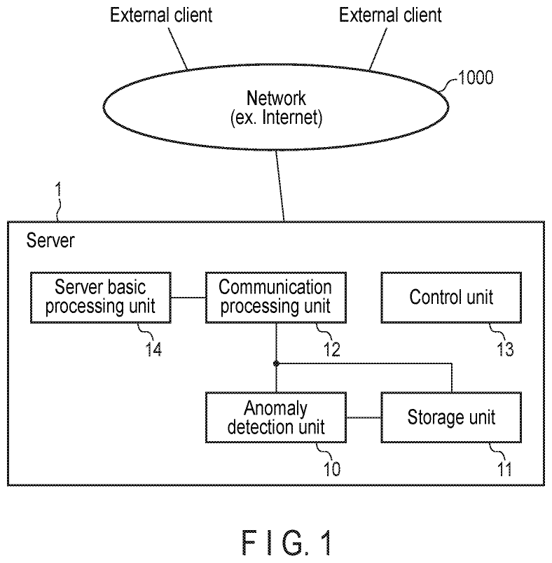

FIG. 1 is a functional block diagram showing an example of a network configuration according to a first embodiment.

A server 1 is constructed by, for example, a computer such as PC. The server 1 is a Web server connected to a network 1000 such as the Internet and connected via a plurality of external clients (hereinafter referred to as external clients) to provide service to the external clients. The external client is constructed by, for example, a computer such as PC.

In the present embodiment, an anomaly detection unit 10 detects anomalies such as cyberattack and unauthorized intrusion into the server 1 using an access log on the server 1. The anomaly detection unit 10 may be constructed as software or hardware on the server 1 or constructed by mixing software and hardware or may be a program which runs on a computer or CPU.

In a storage unit 11, the access log to the server 1 from the external client is stored, for example, information such as the time of access, access source IP addresses, and port numbers is stored. In addition, data sets for the anomaly detection unit 10 to execute machine learning are stored in the storage unit 11. The data sets include a learning data set and an inference data set at the normal operation, an inference data set at the operation in an unknown state, and the like.

A communication processing unit 12 is an interface executing data communication with the external clients, sends data received from the external clients to each function of the server 1 and sends data from each function of the server 1 to the external clients. If the method of the data communication conforms to the method defined in a network, the method is not particularly limited and may be, for example, communication using cables or communication using various wireless systems.

A control unit 13 controls each function of the server 1. In FIG. 1, the control unit 13 is not connected to the other blocks, but exchanges data with each of the functions and controls the functions.

A server basic processing unit 14 includes basic functions of the server 1 to provide services to the external clients, and the like, particularly, a processing function which is not specifically related to the anomaly detection unit 10.

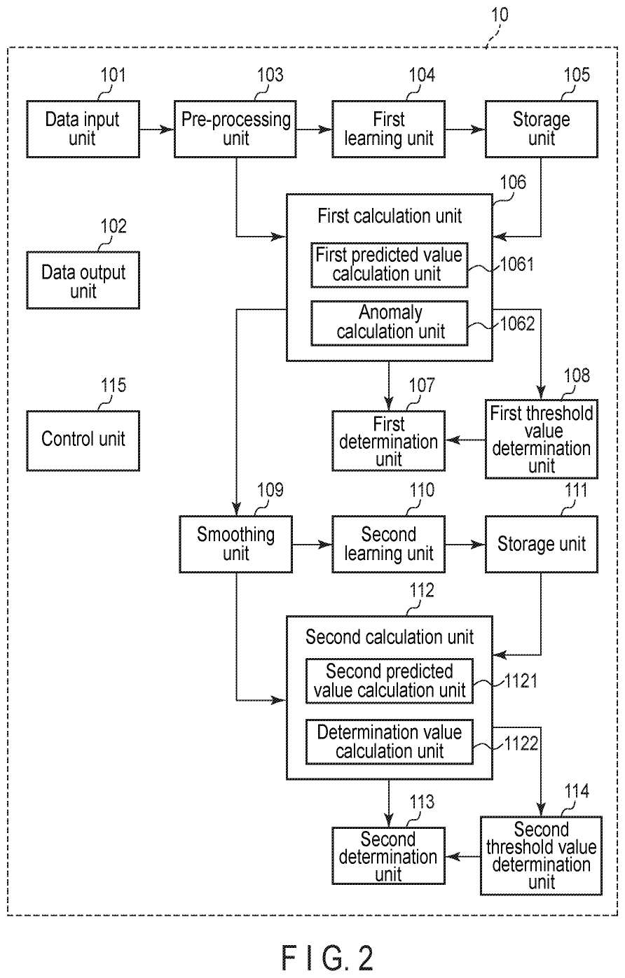

FIG. 2 is a functional block diagram showing an example of a functional configuration of an anomaly detection unit 10 according to the embodiment.

A data input unit 101 is a data input unit which takes data in the anomaly detection unit 10, and data are input from the storage unit 11 and the communication processing unit 12 to the data input unit 101. The data input to the data input unit 101 are hereinafter referred to as system data. For example, the system data are the files where data are accumulated in a format conforming to the specifications of Web servers, similarly to access logs in the Web servers. Therefore, not only numeric data, but characters such as comments are may be included in the system data.

A data output unit 102 is a data output unit which outputs data to the outside of the anomaly detection unit 10. For example, the data output unit 102 outputs “a determination result of the anomaly detection” generated by the anomaly detection unit 10 to a display unit (not shown) and the like. The display unit (not shown) makes, for example, an alarm notice to the user, based on the input determination result.

A pre-processing unit 103 executes processing such as data standardization and data cleaning and output the data such that the data input from the data input unit 101 can be processed at following stages. For example, when the obtained data are character string data, the pre-processing unit 103 quantifies the data, and executes standardization and data cleaning as needed. The processing method in the pre-processing unit 103 needs to execute processing in accordance with the form, type, and the like of the data and is not limited to a fixed method. The data generated and output by the pre-processing unit 103 are hereinafter referred to as monitoring data.

In the present embodiment, the monitoring data are time series data of N (N is a natural number) dimensions, and indicate an example of N types of the time series data included in the access logs of the Web servers. The monitoring data are, desirably, time series data of one or more dimensions each having time dependence but is not particularly limited. More specifically, the monitoring data are the IP addresses and port numbers linked to the acquisition times included in the access log. Two types of time series data of the IP address and the port number may be generated with N=2 but, in the present embodiment, the IP address and the port number are converted into binary data (bits) to generate time series data per bit. For example, since the IP address in IPv4 is composed of 32 bits, the IP address is considered as 32 types of time series data. In addition, similarly, when the port number is considered as 16-bit numerical data, the port number is considered to be composed of 16 types of time series data. Therefore, in the present embodiment, the monitoring data is output as time series data of N=48 (=32+16).

Thus, the time series data of the IP address and the port number at time t are represented below where a time series data number of the IP address is referred to as Na and a time series data number of the port number is referred to as Nb.

IP address: (a1(t), a2(t), . . . , aNa(t))

Port No.: (b1(t), b2(t), . . . , bNb(t))

When monitoring data at time t which the pre-processing unit 103 outputs is referred to as x(t), the IP address and the port number are arranged parallel and defined as follows.

$$\begin{matrix}Monitoring data \text{:} x ( t ) = ( a 1 ( t ) , … , aNa ( t ) , b 1 ( t ) , … , bNb ( t ) ) \\ = ( x 1 ( t ) , … , xi ( t ) , … , xNx ( t ) )\end{matrix}$$

where Nx=Na+Nb and, in the above concrete example, Nx=48.

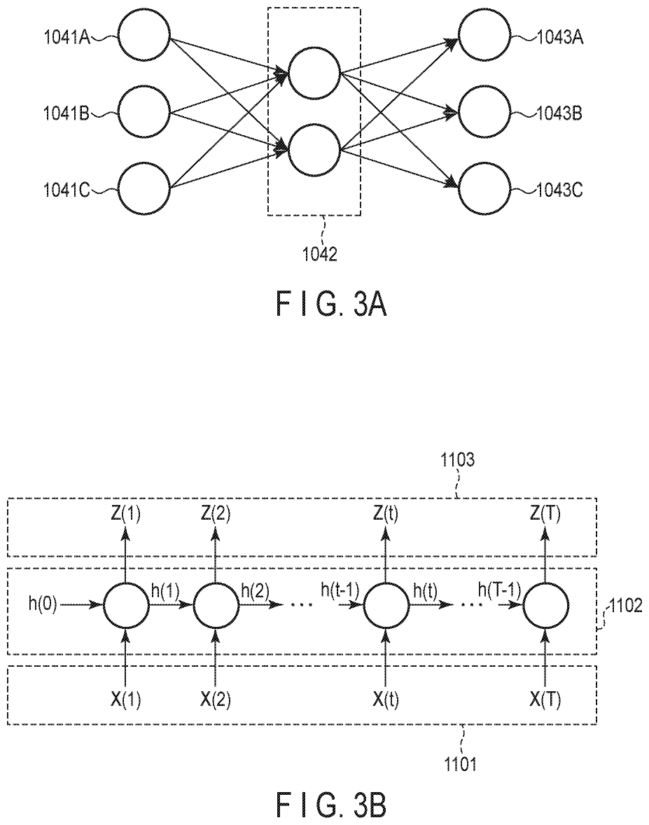

A first learning unit 104 calculates a correlation model parameter to specify a correlation model by machine learning from the monitoring data of N dimensions input by the pre-processing unit 103. In the present embodiment, Auto Encoder is used as a machine learning algorithm in the first learning unit 104. Detailed description of Auto Encoder, which is publicly known, will be omitted here but its brief explanation will be made with reference to FIG. 3A.

FIG. 3A is a diagram showing an example of machine learning in a first learning unit according to the embodiment, and an example of Auto Encoder. Input units 1041A, 1041B, and 1041C (hereinafter simply referred to as input units 1041 unless they need to be specifically distinguished as three input units) are input layers where the monitoring data are input. Different monitoring data xi(t) are input to the input units 1041A, 1041B, and 1041C, respectively. In this example, i refers to a natural number of Nx or less and corresponds to the number assigned to each of the input units. For example, i=1 is assigned to the input unit 1041A, i=2 is assigned to the input unit 1041B, and i=3 is assigned to the input unit 1041C. However, the relationship between the input units and i is not limited to this. A hidden layer unit 1042 is a hidden layer which characterizes the correlation model by Auto Encoder. Output units 1043A, 1043B, and 1043C (hereinafter simply referred to as output units 1043 unless they need to be specifically distinguished as three output units) are output layers where the monitoring data are output by Auto Encoder. The number of input units (hereinafter referred to as an input unit number) matches the number of outputs (hereinafter referred to as an output unit number), and the output units 1043A, 1043B, and 1043C become outputs corresponding to inputs of the input units 1041A, 1041B, and 1041C, respectively. Therefore, the same numbers as those assigned to the corresponding input units 1041 are assigned to the output units 1043. More specifically, i=1 is assigned to the output unit 1043A, i=2 is assigned to the output unit 1043B, and i=3 is assigned to the output unit 1043C. In addition, the input unit number and the output unit number match the time series data number Nx of the monitoring data. In FIG. 3A, the example that the input unit number is 3, the output unit number is 3, and the hidden layer unit number is 2 has been illustrated, but each of the input unit number and the output unit number is Nx in the present embodiment.

In addition, the input unit number, the output unit number, the hidden layer unit number, EPOCH, and the like are preset by Auto Encoder before causing the first learning unit 104 to calculate the correlation model parameter. The user may set the setting with a user interface.

The description returns to FIG. 2, and the correlation model parameter calculated by the first learning unit 104 is stored in a storage unit 105.

A first calculation unit 106 includes a first predicted value calculating unit 1061 and an anomaly degree calculating unit 1062.

The first predicted value calculating unit 1061 acquires the correlation model parameter from the storage unit 105, inputs Nx monitoring data input from the pre-processing unit 103 to the input unit of the correlation model (Auto Encoder) specified by the acquired correlation model parameter, and outputs Nx output data (hereinafter referred to as correlation model prediction data) from the output unit. The correlation model prediction data are represented as follows.

Correlation model prediction data: z(t)=(z1(t), . . . zi(t), . . . , zNz(t))

where i is a natural number of Nz or less, and Nz=Nx.

The anomaly degree calculating unit 1062 calculates square errors (hereinafter referred to as first divergence degrees) between the correlation model prediction data zi(t) and the monitoring data xi(t) to all i, and calculates a sum of the square errors as anomaly degree y(t).

Anomaly degree: y(t)=Σ_{i=1}\hat{ }Nz{(zi(t)−xi(t))2}

where Σ_{i=1}\hat{ }Nz{fi(t)} is indicative of a sum (summation) of i=1 to i=Nz at time t of function fi(t).

In the present embodiment, weighting factor k is defined for each number i assigned to each element of the monitoring data xi(t).

Weighting factor: k=(k1, k2, . . . , ki . . . , kNx)

For example, the weighting factor is determined based on the degree of importance of each element i of the monitoring data, the degree of the first divergence degree, and the like. More specifically, the detection rate of the anomaly detection is improved by weighting the data of large first divergence degree by a large value. In addition, when it is preliminarily recognized that specific bits such as LSB and MSB of the IP address included in the monitoring data xi (t) are important for anomaly detection, the weighting factor is used to set ki for the bits to a large value. In general, ki is set to 1 (where i is a natural number of Nx or less). When the weighting factor is considered, the anomaly degree y(t) is set as follows by multiplying (zi(t)−xi(t))2 by ki.

Anomaly degree (with weighting factor): y(t)=Σ_{i=1}\hat{ }Nz{(zi(t)−xi(t))2}

Effects of improving the detection rate of the anomaly detection and decreasing anomaly detection errors can be obtained by considering the weighting factor.

A first determination unit 107 determines whether an anomaly is detected based on the anomaly degree y(t) calculated by the first calculation unit 106 or not. In the present embodiment, determination of the anomaly in the monitoring data of N dimensions can be executed at one-dimensional anomaly degree y(t) and the processing amount of the anomaly detection process can be decreased, by using the anomaly degree y(t) for the determination. In addition, the detection rate of the anomaly detection is improved by executing the determination at the one-dimensional anomaly degree y(t).

A first threshold value determination unit 108 determines a determination criterion such as a threshold value to determine whether the anomaly occurs to the anomaly degree y(t) calculated by the first calculation unit 106 or not. The determination method will be described in the explanation of the operations in the present embodiment.

A smoothing unit 109 smoothes the anomaly degree y(t) which is the input time series data, and outputs the smoothed anomaly degree X(t) (hereinafter referred to as a smooth anomaly degree X(t)). The manner of the smoothing may also be simple moving average. However, the smoothing can be carried out for each monitoring data depending on the characteristics of the monitoring data in parallel, and different smoothing methods may be executed for the monitoring data, respectively, and, for example, are not limited to the same simple moving average. In addition, the manner and the parameter of the smoothing may be determined optionally depending on the characteristics of target data of the abnormal detection. The smoothing is used for purposes such as noise component removal from the time series data y(t) of the anomaly degree, but also has the effect of improvement in the accuracy of the anomaly detection. For example, when the anomaly that the monitoring data are changed only gently for a long time, such as the aging degradation of the device, is detected, the manner and the parameter of the smoothing can also be used to increase the degree of smoothing of y(t) to remove the noise such as instantaneous change. In addition, when the anomaly such as unauthorized intrusion of an information network is detected, the manner and the parameter of the smoothing can also be used to execute no smoothing or to weaken the degree of the smoothing to y(t) since the change of monitoring data needs to be detected urgently.

A second learning unit 110 calculates the time series model parameter to specify the time series model by machine learning from the time series data of the smooth anomaly degree X(t) input from the smoothing unit 109. In the present embodiment, Long-Short Term Memory (hereinafter referred to as LSTM) is used as a machine learning algorithm in the second learning unit 110. LSTM is one of the machine learning algorithms that can handle the time series data having time dependence, but can handle the time series data having longer time dependence than Recurrent Neural Network (hereinafter referred to as RNN) which is machine learning algorithm serving as the base of LSTM. Detailed description of LSTM, which is publicly known, will be omitted but LSTM will be simply explained with reference to FIG. 3B.

FIG. 3B is a diagram showing an example of machine learning in the second learning unit according to the embodiment, and an example of LSTM.

The smooth anomaly degree X(t) is input at time t from the smoothing unit 109 to an input unit 1101. A hidden layer 1102 is a hidden layer characterizing the time series model, and a time series model parameter h(t) is calculated at time t by machine learning. An output unit 1103 outputs prediction data Z(t) to the smooth anomaly degree X(t) calculated at time t using the time series model characterized by h(t-1). In FIG. 3B, the state that the relation in which the prediction data Z(t) is output from the input data X(t) and the time series model parameter h(t-1) changes from t=1 to t=T is shown. The description returns to FIG. 2, and the time series model parameter calculated by the second learning unit 110 is stored in the storage unit 111.

A second calculation unit 112 includes a second predicted value calculating unit 1121 and a determined value calculating unit 1122.

The second predicted value calculating unit 1121 acquires a time series model parameter from the storage unit 111, inputs the smooth anomaly degree X(t) input from the smoothing unit 109 to the input unit 1101 of the time series model (LTSM) specified by the acquired time series model parameter, and calculates the time series model prediction data Z(t) from the output unit 1103.

The determined value calculating unit 1122 calculates a square error between the time series model prediction data Z(t) and the smooth anomaly degree X(t), and calculates the square error as the anomaly determination value Y(t).

A second determination unit 113 determines whether the anomaly is detected based on the anomaly determination value Y(t) calculated by the second calculation unit 112 or not.

A second threshold value determination unit 114 determines a determination criterion such as a threshold value to determine whether anomaly occurs to the anomaly determination value Y(t) calculated by the second calculation unit 112 or not. The determination method will be described in the explanation of the operations in the present embodiment.

A control unit 115 controls each function of the anomaly detection unit 10. In FIG. 2, the control unit 115 is not particularly connected, but exchanges data with each function and controls the function.

An operation example of the system according to the present embodiment will be described below.

In the system according to the present embodiment, model learning is completed by the machine learning and then the system is managed using the learned model.

### (Operation Example of Model Learning Using Machine Learning and Model Evaluation)

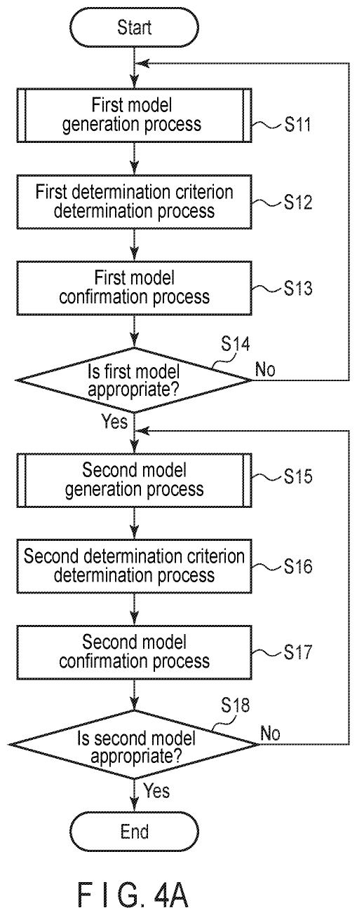

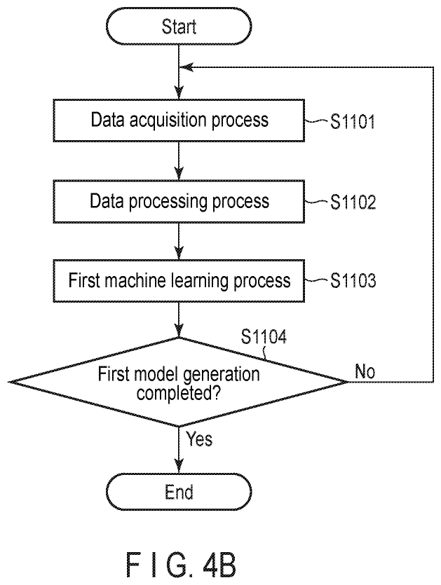

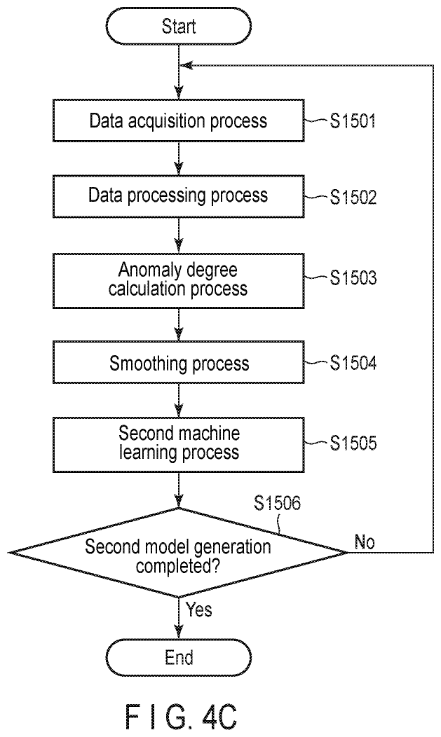

FIG. 4A is a flowchart showing an example of a process operation at generation of first and second models of the anomaly detection unit according to the embodiment, and an example of a process operation in model learning by machine learning of the anomaly detection unit 10.

An access log (system data) stored in the storage unit 11 is input to the data input unit 101 and a correlation model generation process is executed by machine learning (Auto Encoder) at the first learning unit 104 (step S11). The system data used herein is assumed to be data that has been acquired at a normal operation time, i.e., data acquired when the anomaly does not occur, and is referred to as data for learning. In addition, for example, the normal operation time is not an unsteady period when a device is just started, and is desirably selected as a steady time when the device is operated for a long term to some extent and no anomaly occurs.

FIG. 4B is a flowchart showing an example of the detailed process operation at the first model generation time of the anomaly detection unit according to the embodiment, illustrating details of step S11 of FIG. 4A.

The data input unit 101 acquires the data for learning and outputs the data to the pre-processing unit 103 (step S1101). The pre-processing unit 103 extracts the data necessary for anomaly detection from the input data for learning, and a first learning unit 104 of the subsequent stage converts the data into a processable data format and outputs the data to the first learning unit 104 as monitoring data (step S1102). In the present embodiment, the pre-processing unit 103 extracts the data of the IP address and the port number, and the time when the data are acquired, converts the data of the IP address and the port number into binary data, and outputs the data as time series monitoring data x(t). The first learning unit 104 inputs the monitoring data x(t) from the input units 1041 and executes first machine learning (step S1103). More specifically, the first learning unit 104 determines a correlation model parameter of Auto Encoder, which is a machine learning algorithm, by machine learning using sufficient learning data. The first learning unit 104 repeats the process from step S1101 to step S1104 until executing the first machine learning with a sufficient amount of the data for learning (NO in step S1104). When the first learning unit 104 executes the first machine learning with a sufficient amount of the data for learning, the first learning unit 104 completes generation of the first model (YES in step S1104). The first learning unit 104 stores the generated first model of the correlation model parameter in the storage unit 105.

The description returns to FIG. 4A, and when the first learning unit 104 generates a correlation model with the data for learning, the first learning unit 104 executes criterion determination for validation of the correlation model with data other than the data used as the data for learning of the access log stored in the storage unit 11 (step S12). The data used herein are data acquired at the normal operation time, similarly to the data for learning, and are referred to as data for setting the determination criterion for the data for learning. More specifically, the process is executed in the following flow.

When the data for setting the determination criterion are input from the data input unit 101, the data input 101 outputs the data to the first calculation unit 106 as the monitoring data x(t). The first calculation unit 106 calculates the correlation model prediction parameter, i.e., z(t), for the monitoring data x(t), using the correlation model parameter stored in the storage unit 105. The first calculation unit calculates anomaly degree y(t) from the monitoring data x(t) and the calculated z(t), and outputs the anomaly degree y(t) to the first threshold value determination unit 108. The first threshold value determination unit 108 accumulates the anomaly degree y(t) in the storage unit (not shown) and forms, for example, data distribution such as probability density distribution and accumulated density distribution.

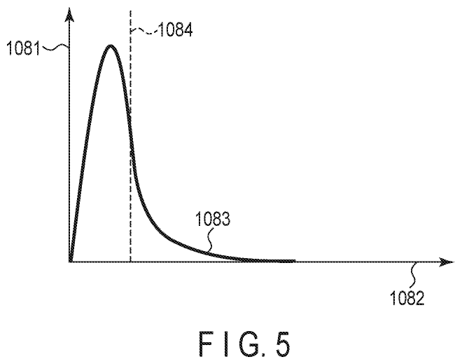

FIG. 5 is a graph showing an example of a threshold determination method executed by the threshold determination unit according to the embodiment, illustrating an example of the probability density distribution formed using the accumulated anomaly degree y(t).

A vertical axis 1081 is indicative of the value of the probability density. A horizontal axis 1082 is indicative of the value of the accumulated data and, in this example, the anomaly degree value. A distribution 1083 is indicative of an example of the probability density distribution, and a threshold value 1084 is indicative of the threshold value to the anomaly degree value.

For example, the value 90% of the cumulative probability of the distribution 1083 is determined as a threshold value 1084. The threshold value 1084 for the anomaly degree is referred to as a first threshold value. The determined first threshold value is stored in a storage unit (not shown) of the first threshold value determination unit 108. In the present embodiment, the value of 90% is used but the value is not limit to 90% and the user can set an arbitrary value to 0% to 100%.

Examples of criterion for the evaluation of validation of the model include, for example, a method using the ratio obtained from the number of data which fall within the threshold value, of the total number of data of the data distribution, and a method using the accuracy calculated using a confusion matrix. The determination of the threshold value is executed as needed after the threshold value is once determined, and the frequency of determination is determined depending on the number of times of learning.

When the determination criterion for confirmation of the correlation model using the data for setting the determination criterion is determined in step S12, validation of the correlation model is executed by using data other than the data for learning of the access log stored in the storage unit 11 and the data used as the data for setting the determination criterion (step S13). The data used herein are assumed to be the data acquired at the normal operation time, similarly to the data for learning and the data for setting the determination criterion, and are referred to as data for inference. More specifically, the validation of the correlation model is executed as described follows.

Similarly to the case of the data for setting the determination criterion, the first calculation unit calculates the anomaly degree y(t) to the data for inference, stores the anomaly degree y(t) in the storage unit (not shown) of the first threshold value determination unit 108, and forms a data distribution of a probability density function. The data distribution formed here does not include the data calculated from the data for setting the determination criterion. When the anomaly degree y(t) data are stored to sufficient data for inference, the first determination unit 107 compares a 90% value of the data distribution with the first threshold value stored in the first threshold value determination unit 108 (step S14).

If the 90% value of the data distribution is larger than the first threshold value as a result of comparison executed by the first determination unit 107, the first determination unit 107 determines that the correlation model is not formed exactly. When the first determination unit 107 outputs the determination result to the control unit 115, the control unit 115 causes a display (not shown) such as a monitor to display, for example, “validation of the correlation model cannot be confirmed” to notify the user of an alarm. The first model generation process of step S11 is executed again by the user (NO in step S14). When executing step S11 again, the user changes the hidden layer unit number and Epoch of the correlation model (Auto Encoder) and the like, and executes the step again by using the same data for learning. In addition, the user may execute step S11 by changing the data for learning without changing the hidden layer unit number or Epoch, increasing the amount of the data for learning and executing the machine learning again (extending the learning period of the machine learning), and the like. In addition, in the present embodiment, the example that the user receiving the alarm notice restarts step S11 has been described but, for example, the change of the hidden layer unit number, Epoch, the learning data and the like and the validation of the correlation model may be automated by programs or the like.

When the 90% value of the data distribution is smaller than the first threshold value as a result of the comparison executed by the first determination unit 107, in step S14, the first determination unit 107 determines that the correlation model is formed exactly and the process proceeds to step S15 (YES in step S14).

The learning data used when the first determination unit 107 confirms that the correlation model is formed exactly are input to the data input unit 101 again, and time series model generation process is executed by machine learning (for example, LTSM) in the second learning unit 110 (step S15). More specifically, a flow as illustrated in the following example is executed.

FIG. 4C is a flowchart showing an example of the detailed process operation at the second model generation time of the anomaly detection unit according to the embodiment, illustrating the details of step 15 of FIG. 4A.

The data input unit 101 acquires the data for learning and outputs the data to the pre-processing unit 103 (step S1501). The pre-processing unit 103 extracts the data necessary for anomaly detection from the input data for learning, and the first learning unit 104 of the subsequent stage converts the data into a processable data format and outputs the data to the first learning unit 104 as monitoring data (step S1502). The first calculation unit 106 calculates the anomaly degree y(t) from the input monitoring data and the first model having the validation confirmed in step S14 (step S1503). The anomaly degree y(t) is input to the smoothing unit 109, and the smoothing unit 109 outputs the smoothed anomaly degree X(t) (step S1504). The smoothed anomaly degree X(t) is input to the second learning unit 110, and the second learning unit 110 executes second machine learning with the smoothed anomaly degree X(t) (step S1505). More specifically, the second learning unit 110 calculates a time series model parameter for specifying the time series model, which is a second model. The second learning unit 110 repeats the process from step S1501 to step S1506 until executing second machine learning with a sufficient amount of the data for learning (NO in step S1506). When the second learning unit 110 executes the second machine learning with a sufficient amount of the data for learning, generation of the second model is completed (YES in step S1506). The second learning unit 110 stores the generated second model of the correlation model parameter in the storage unit 111 (step S15).

The description returns to FIG. 4A, and when the generation of the time series model executed by the second learning unit 110 is completed, the criterion determination for the validation of the time series model is executed with the data for setting the determination criterion used in step S12 (step S16). More specifically, the process is executed in the following flow.

The anomaly determination value Y(t) calculated by the second calculation unit 112 for the data for setting the determination criterion input to the data input unit 101 is accumulated in a storage unit (not shown) of the second threshold value determination unit 114 and, for example, the data distribution 1083 of the probability density function shown in FIG. 5 is formed. Similarly to step S12, for example, the 90% value of the distribution is determined as a second threshold value (corresponding to the threshold value 1084 in FIG. 5), based on the data distribution for the obtained anomaly determination value. The determined second threshold value is stored in a storage unit (not shown) of the second threshold value determination unit 112 (step S16).

When the determination criterion for the confirmation of the time series model is determined in step S16, the validation of the time series model is executed with the data for inference used in step S13 (step S17).

More specifically, the validation of the time series model is executed as described follows. The second determination unit 112 calculates the anomaly determination value Y(t) to the data for inference, stores the anomaly determination value Y(t) in a storage unit (not shown) of the second threshold value determination unit 114, and forms a data distribution of a probability density function. The second determination unit 113 compares a 90% value of the data distribution with the second threshold value stored in the second threshold value determination unit 114 (step S18).

If the 90% value of the data distribution is larger than the first threshold value as a result of comparison executed by the second determination unit 113, the second determination unit 113 determines that the time series model is not formed exactly. When the second determination unit 113 outputs the determination result to the control unit 115, the control unit 115 causes a display (not shown) such as a monitor to display, for example, “validation of the time series model cannot to confirmed” to notify the user of an alarm. The second model generation process of step S15 is executed again by the user (NO in step S18). When step S15 is executed again, the user changes the setting parameter such as the number of time series model parameters h(t) necessary to calculate the hidden layer unit number and the time series model prediction model Z(t) to execute learning again with the data for learning used in S15. In addition, the user may execute step S15 by using data for learning different from the data used in S15 without changing the setting parameter, executing the machine learning again with a large amount of the data for learning (extending the learning period of the machine learning), and the like. In addition, in the present embodiment, the example that the user receiving the alarm notice restarts step S15 has been described but, for example, the change of the setting parameter and the validation of the time series model may be automated by programs or the like.

When the 90% value of the data distribution is smaller than the second threshold value as a result of the comparison executed by the second determination unit 113, in step S18, the second determination unit 113 determines that the time series model is formed exactly and the generation processes of the correlation model and the time series model are finished (YES in step S18). The normal operation status of the server 1, which is the anomaly detected device, can be modeled by the correlation model generated in the above steps.

Incidentally, when the validation of the correlation model and the time series model is executed in steps S14 and S18, the display unit (not shown) may be caused to display “correlation model is generated exactly”, “time series model is generated exactly”, or the like to notify the user of the display. (Operation example at anomaly detection operation)

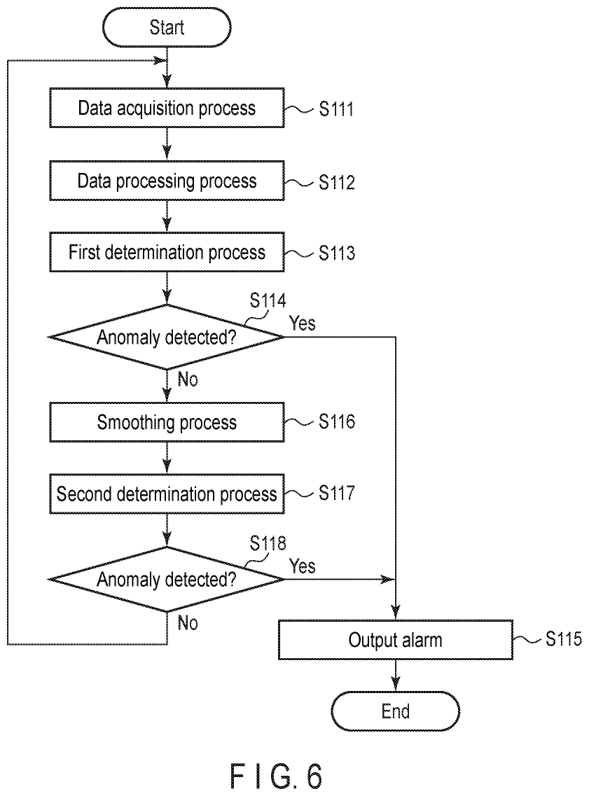

FIG. 6 is a flowchart showing an example of a process operation at use of the anomaly detection unit according to the embodiment.

The data input unit 101 of the anomaly detection unit 10 acquires system data (step S111). The system data used here is referred to as operation data for the system data used at the above model generation. The operation data is temporarily stored in a storage unit of a buffer (not shown) or the like as an access log, in the communication processing unit 12 or the server basic processing unit 14 when, for example, an external client accesses the server 1. The data input unit 101 acquires accesses a buffer (not shown) and acquires the operation data. Rapid anomaly detection can be executed by setting a cycle in which the data input unit 101 acquires the operation data to a time as short as possible. In addition, the data input unit 101 may acquire the access only when the access log data is changed. For example, when the control unit 13 of the server 1 detects change of the access log data and instructs the control unit 115 of the anomaly detection unit 10 to start the anomaly detection, the control unit 115 may cause the data input unit 101 to acquire the access log and to execute a subsequent process for the only system data of the changed part.

When the operation data is input to the pre-processing unit 103, the pre-processing unit 103 outputs the monitoring data x(t) (step S112). when the monitoring data x(t) is input to the first calculation unit 106, the first calculation unit 106 calculates the anomaly degree y(t) and outputs the anomaly degree y(t) to the first determination unit 107. The first determination unit 107 compares the input anomaly degree y(t) with the first threshold value stored in the first threshold value determination unit 108, and determines whether an anomaly is included in the acquired use data or not (step S113). More specifically, when the anomaly degree y(t) is larger than the first threshold value, the first determination unit 107 determines that “an anomaly occurs in the Web server (server 1)” and causes a display unit such as a monitor (not shown) to display “anomaly occurs at Web server” to notify the user of an alarm (YES in step S114, and S115).

When anomaly degree y(t) is smaller than the first threshold value (NO in step S114), the first determination unit 107 determines “no anomaly in the Web server” and the process proceeds to step 5116.

The anomaly degree y(t) is input to the smoothing unit 109, and the smoothing unit 109 outputs the smoothed anomaly degree X(t) to the second calculation unit 112 (step S116). The second calculation unit 112 calculates the anomaly determination value Y(t) and outputs the value to the second determination unit 113. The second determination unit 113 compares the input anomaly determination value Y(t) with the second threshold value stored in the second threshold value determination unit 114, and determines whether an anomaly is included in the acquired use data or not (step S117).

When the anomaly determination value Y(t) is larger than the second threshold value, the second determination unit 113 determines that “an anomaly occurs in the Web server (server 1)” and causes a display unit such as a monitor (not shown) to display “anomaly occurs at Web server” to notify the user of an alarm (YES in step 5118, and S115).

When the anomaly determination value Y(t) is smaller than the second threshold value, the second determination unit 113 determines “no anomaly in the Web server” and acquires next system data (NO in step S118, and S111).

Thus, according to the present embodiment, determination of the anomaly in the monitoring data of N dimensions can be executed at one-dimensional anomaly degree y(t) and the processing amount of the anomaly detection process can be decreased, by using the anomaly degree y(t) for the determination.

In addition, the present embodiment can provide an anomaly detection method of efficiently processing a large amount of sensor values (in the present embodiment, type Nx=48 of the monitoring data) and rapidly detecting the anomaly with high accuracy by setting the second threshold value for determining the anomaly detection for the calculated anomaly degree y(t).

Incidentally, in the present embodiment, the machine learning algorithm at the second learning unit 110 is set to be LTSM but, for example, RNN or a machine learning algorithm such as Gated Recurrent Unit (hereinafter referred to as GRU), which is a variant of LTSM, may be used.

In GRU, a forgetting gate and an input gate of LSTM are integrated into one gate as an update gate, and three gates, i.e., an update gate, a forgetting gate, and an output gate are set while four gates are set in LSTM, and the parameter number and the processing amount are more reduced than those in LSTM. That is, GRU is an algorithm which can easily maintain the memory on characteristics of long-cycle data, similarly to LSTM, in a structure simpler than that in LSTM.

When RNN and GRU are also applied to the machine learning algorithm at the second learning unit 110, the anomaly detection can be executed in the manners shown in FIG. 4A and FIG. 6, similarly to the case of LSTM.

Thus, in the present embodiment, the effect of improving the anomaly detection accuracy can be obtained since not only a large amount of sensor values can be calculated simultaneously but the time series variations of the respective sensor values can be considered. In addition, an effect of improving the anomaly detection rate can be obtained since opportunities of anomaly detection can be increased. Based on the above, the present embodiment can also be used for anomaly detection in an information network in which cyberattack becomes complicated.

Incidentally, in the present embodiment, the example of executing the anomaly detection by acquiring the operation data in real time and comparing the anomaly determination value Y(t) with the second threshold value, at the anomaly detection operation, has been described, but the anomaly determination values Y(t) on the operation data may be stored for a certain period and the anomaly detection may be determined for the stored data. For example, an anomaly detection rate (Accuracy) may be calculated as the rate of the data on the anomaly determination values exceeding a certain threshold value of the data of the stored anomaly determination values, and the normal or anomaly status may be determined by determining whether the rate exceeds an arbitrarily determined threshold value of the anomaly detection rate or not. More specifically, when the stored data number before time t of the anomaly determination value is referred to as NY(t) and the number of anomaly determination values exceeding the second threshold value, of the stored data number, is referred to as Nab(t), the anomaly detection rate is obtained as A(t)=Nab(t)/NY(t). When a third threshold value for PA(t) is set to, for example, 80% and PA(t) becomes larger than 80%, it is determined that an anomaly occurs. In addition, the same concept can also be used for the anomaly detection and determination at the first determination unit.

### Second Embodiment

In the present embodiment, an example of assuming a plurality of detected devices comprising a plurality of sensors as detection targets, and executing failure detection and failure prediction of the detected devices will be illustrated. The example of the anomaly detection on the network has been illustrated in the first embodiment but, for example, an example of anomaly detection at devices and installations connected to a network in a factory will be illustrated in the present embodiment.

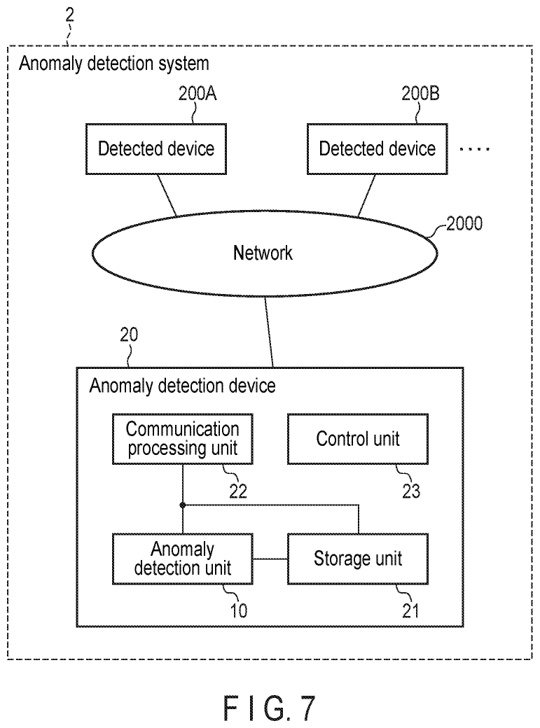

FIG. 7 is a functional block diagram showing an example of a configuration of an anomaly detection system according to a second embodiment.

An anomaly detection system 2 comprises an anomaly detection device 20 and one or more detected devices 200 (in the drawing, 200A and 200B; hereinafter referred to as 200 unless the devices need to be particularly distinguished), and each of them is connected to a network 2000. The network 2000 is described as an example of the closed network in consideration of the situation that the anomaly detection device 20 and the detected device 200 are used at a closed place such as factory. However, the network is not limited to the closed network, but may be the Internet, and may not only be a wired network but a wireless network.

The anomaly detection device 20 is composed of, for example, a computer such as PC and comprises the anomaly detection unit 10 shown in FIG. 1. In addition, a storage unit 21, a communication processing unit 23, and a control unit 24 have the same functions as the storage unit 11, the communication processing unit 12, and the control unit 13 shown in FIG. 1, but the descriptions are omitted here.

The detected device 200 comprises one or more sensors and sends data acquired by the sensors to the anomaly detection system. For example, the detected device 200 may not only be a computer such as PC, but a machine installation or vehicle used in a factory or the like comprising a sensor. In the drawing, an example that the number of detected devices is two as the detected devices 200A and 200B is illustrated, but the number of detected devices is not particularly limited but may be an arbitrary number of one or more.

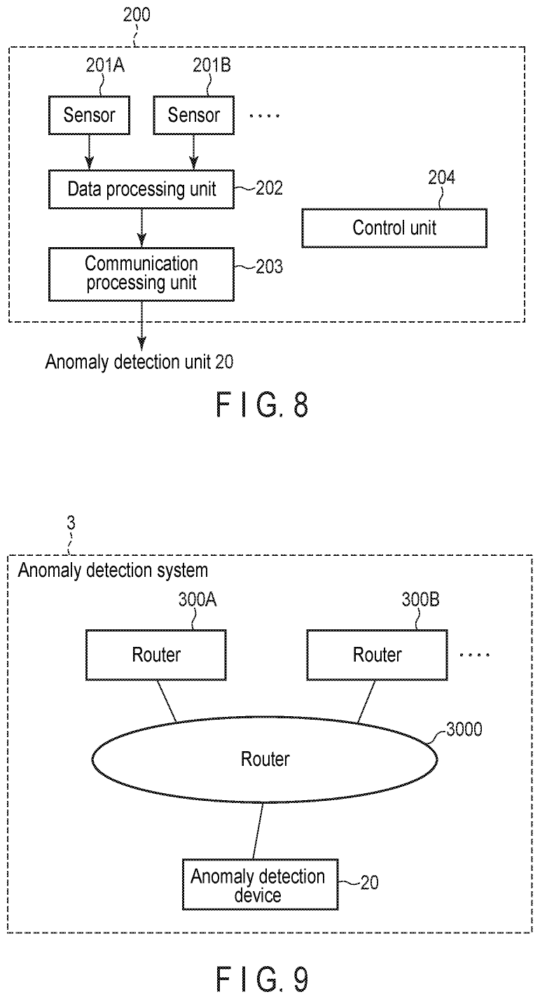

FIG. 8 is a functional block diagram showing an example of a functional configuration of a detected device according to the embodiment.

The detected device 200 outputs various types of data from sensors 201 (in the drawing, sensors 201A and 201B; hereinafter referred to as 201 unless the sensors need to be particularly distinguished). The type of the sensors 201 is not particularly limited, but may be, for example, a temperature sensor, an acceleration sensor, a microphone serving as an acoustic sensor, a camera or video recorder as an optical sensor, or the like. In addition, an example that the number of sensors serving as the sensors 201A and 202B is two is illustrated in the drawing, but the number of sensors is not particularly limited but may be an arbitrary number of one or more. Furthermore, the number and type of the sensors 201 provided in the detected device 200 may be different.

A data processing unit 202 converts various types of sensor data output from the sensors 201 into binary data, processes the data into data in a predetermined format and outputs the processed data.

A communication processing unit 203 forms an existing format and outputs the format to the network to send the data output from the data processing unit 202 to the anomaly detection device 20. The sent data corresponding to the sensors is referred to as sensor data.

A control unit 204 controls each function of the detected device 200. For example, the control unit 204 controls data output to the sensors 201 under an instruction from the anomaly detection device 20.

An operation example of the system according to the present embodiment will be described below. Each detected device 200 sends predetermined sensor data to the anomaly detection device 20. In the present embodiment, a situation that the sensor data are collected from the detected devices 200 at any time is assumed, but the anomaly detection device 20 may be able to arbitrarily collect the sensor data as needed. In addition, in the present embodiment, a situation that the anomaly detection device 20 collects the sensor data via the network is assumed, but the sensor data can also be input from the detected devices 200 to the anomaly detection device 20 via the other device such as a data collection unit or the like. The anomaly detection device 20 receives sensor data by the communication processing unit 23 and inputs the sensor data in the anomaly detection unit 10 and the storage unit 21.

A process at the anomaly detection device 20 is the same as the process described in the first embodiment. That is, the anomaly detection device 20 inputs the sensor data stored in the storage unit 21 to the data input unit 101 of the anomaly detection unit 10, and the pre-processing unit 103 generates and outputs monitoring data x(t). The monitoring data x(t) will be described below.

Monitoring data output from the pre-processing unit 103, to the sensor data of the detected device 200A input to the data input unit 101, is referred to as x_a(t). In addition, monitoring data to the sensor data of the detected device 200B is referred to as x_b(t).

For example, when data are output from Nsa sensors of the detected device 200A and data are output from Nsb sensors of the detected device 200B,

Monitoring data from the detected device 200A:

x_a(t)=(a1(t), a2(t), . . . , aNsa(t))

Monitoring data from the detected device 200B: x_b(t)=(b1(t), b2(t), . . . , bNsb(t))

Therefore, the monitoring data x(t) is as follows based on x_a(t) and x_b(t).

Monitoring data: x(t)=(a1(t), . . . , aNsa(t), b1(t), . . . , bNsb(t))=(x1(t), . . . , xi(t), . . . , xNx(t)) where Nx=Nsa+Nsb. Each element of x(t) is binary data in the first embodiment, but may be a real number in the present embodiment.

The anomaly detection can be executed by executing the same process as the process described in the first embodiment, with the monitoring data x(t) obtained as described above. More specifically, the correlation model and the time series model are determined in the flowchart of FIG. 4A. When the correlation model and the time series model are determined and the operation of anomaly detection starts, the anomaly detection can be executed by executing the process according to the flowchart of FIG. 6.

Thus, the present embodiment can provide an anomaly detection device capable of rapidly detecting the anomaly with good accuracy as the anomaly detection system, assuming a factory where a plurality of detected devices comprising a plurality of sensors are installed.

In addition, the anomaly detection method of the present embodiment can recognize correlation between different sensors, based on the sensor data from the sensor group, predict an anomaly occurrence pattern from the time series variation of the parameters indicative of variation and correlation of behaviors of the anomaly detection device, based on the correlative variation of the sensors, and rapidly detect the anomaly.

### Third Embodiment

In the present embodiment, an example of detecting cyberattack and unauthorized intrusion from an external network by analyzing access log to a router in an information network will be described.

FIG. 9 is a functional block diagram showing an example of an anomaly detection system according to a third embodiment.

In an anomaly detection system 3, an anomaly detection device 20 and a plurality of routers 300A and 300B (hereinafter referred to as routers 300 unless the routers need to be particularly distinguished), are connected to a network 3000.

The anomaly detection device 20 is equivalent to the anomaly detection device 20 of FIG. 7 as illustrated in the second embodiment.

The network 3000 is assumed to be a network isolated from a public network such as the Internet by the firewall, for example, a corporate intranet.

The routers 300 are router units used in the information network and have, for example, firewalls installed therein, and have a role of a boundary and bridge between the corporate intranet and the Internet. In addition, two routers 300A and 300B are shown in FIG. 9 but the number of routers is not particularly limited.

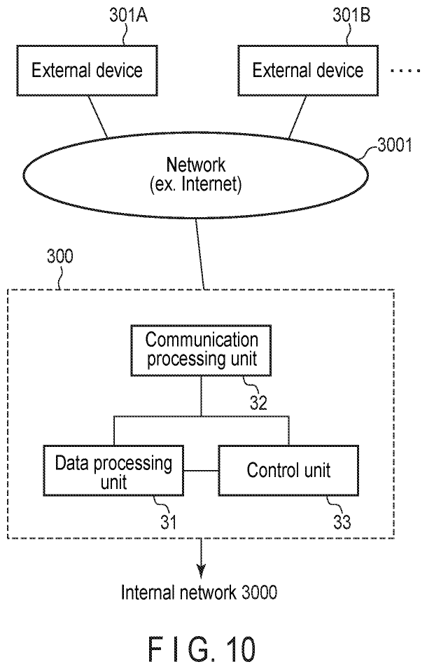

FIG. 10 is a functional block diagram showing an example of a network configuration according to the embodiment, illustrating an example of a network configuration on the Internet side from the routers 300.

The router 300 comprises a data processing unit 31, a communication processing unit 32, and a control unit 33.

A network 3001 is assumed to be a public network such as the Internet which a large number of unspecified persons can access.

External devices 301A and 301B are devices which can be connected to the network 3001 and may include a large number of unspecified devices. The external devices may be, for example, PC, smartphones, and the like.

An operation example of the system according to the present embodiment will be described below.

The anomaly detection device 20 acquires an access log from each router 300 and inputs the access log to the anomaly detection unit 10 and the storage unit 21. To detect an anomaly as rapidly as possible, the access log should desirably be transmitted from each router 300 to the anomaly detection device 20 in a short period.

The access log of each router 300 is indicative of an IP address of the external device 301 which has accessed each router 300, the IP address of the access destination, a port number, and the like.

The process in the anomaly detection device 20 is equivalent to the process described in the first embodiment and the second embodiment.

That is, the anomaly detection device 20 inputs the access log (corresponding to the sensor data) stored in the storage unit 21 to the data input unit 101 of the anomaly detection unit 10, and outputs the monitoring data x(t). The monitoring data x(t) will be described below.

The pre-processing unit 103 performs processes such as data standardization, data cleaning, and the extraction for the input access log and outputs the monitoring data x(t). The setting of the monitoring data x(t) is performed by a method 1 of dividing data for each router 300, or a method 2 of once collecting the data of all the routers 300, sorting the data by the time, and handling the data as time series data for each type of data which do not depend on the routers 300. Desirably, the method 1 is used when the situation of the access of each router 300 is focused, and the method 2 is used when the situation of the access to the inside of the anomaly detection system is focused.

In the method 1, the monitoring data x(t) is as follows. In FIG. 10, two examples of the external devices 301A and 301B are shown, but the situation that Nra external devices and Nrb external devices are connected to the routers 300A and 300B, respectively, is assumed.

Monitoring data to the access log of the rooter 300A: x_ra(t)=(a1(t), a2(t), . . . , aNra(t))

Monitoring data to the access log of the router 300B: x_rb(t)=(b1(t), b2(t), . . . , bNrb(t))

Therefore, the pre-processing unit 103 can obtain the monitoring data based on x_ra(t) and x_rb(t) in the following manner. Nx=Nra+Nrb.

Monitoring data: x(t)=(a1(t), . . . , aNra(t), b1(t), . . . , bNrb(t))=(x1(t), . . . , xi(t), . . . , xNx(t)).

In addition, in the method 2, the pre-processing unit 103 sorts all the data by time and obtains the monitoring data as described below. Nx=Nra+Nrb. Monitoring data: x(t)=(x1(t), . . . , xi(t), . . . , xNx(t))

In addition, each element of x(t) obtained by the method 1 and the method 2 may be binary data, or may be a real number in the present embodiment. In the case where the element is a real number, the element is normalized to a value from 0 to 1 by the pre-processing unit 103.

The anomaly detection can be executed by executing the same process as the process described in the first embodiment, with the monitoring data x(t) obtained as described above. More specifically, the correlation model and the time series model are determined in the flowchart of FIG. 4A. When the correlation model and the time series model are determined and the operation of anomaly detection starts, the anomaly detection can be executed by executing the process according to the flowchart of FIG. 6.

According to the present embodiment, as described above, the anomaly detection system of rapidly detecting the anomaly such as a server attack or unauthorized access with good accuracy, in the situation such as the Internet that a large number of unspecified external devices 301 are accessible to the routers 300 can be provided.

According to at least one embodiment described above, the anomaly detection device, the anomaly detection method, and the anomaly detection program of efficiently processing a large amount of sensor values and rapidly detecting the anomaly with good accuracy can be provided.

Incidentally, any embodiments of the first to third embodiments or any methods used in each embodiment may be combined. Furthermore, in the embodiments, the methods used in the embodiments can be changed.

The elements in the above system can also be described as follows.

(A-1)

An anomaly detection method comprising:

a data collection process of collecting a plurality of types of input data (step S111 in FIG. 6); a pretreatment process of performing normalization of the collected data and processing when data lack (step S112 in FIG. 6);

a correlation model generation process of generating a correlation model of the input data by performing machine learning of data when the collected data are normal (steps S11 to S13 in FIG. 4A);

a first detection process of evaluating a divergence degree between each input node and each output node to the correlation model, in relation to a plurality of types of data at arbitrary evaluation (step S113 in FIG. 6);

an anomaly degree extraction process (step S113 in FIG. 6) of extracting a sum of divergence degrees of the output nodes, in relation to the divergence degree from the normal status (step S113 in FIG. 6);

a smoothing process of smoothing time series data of the sum of the divergence degrees, which is extracted in the anomaly degree extraction process (step S116 in FIG. 6);

a time series model generation process of generating a time series model at a normal time by inputting the time series data of the sum of the divergence degrees smoothed in the smoothing process to machine learning (steps S15 to S17 in FIG. 4A); and
a second detection process of evaluating a divergence degree from the time series model in relation to the time series data of the sum of the divergence degrees at an arbitrary evaluation (step S117 in FIG. 6).

(A-2)

The anomaly detection method of (A-1), wherein

based on input data including time variation, the machine learning is performed such that the time variation is included in a feature vector, in the correlation model generation process.

(A-3)

The anomaly detection method of (A-2), wherein in the correlation model generation process, the correlation model is generated with Auto Encoder, and

in the first detection process, an error or squared error between an input value to the correlation model and an output value is calculated as a divergence degree from the normal status, and an anomaly is determined when the divergence degree is larger than or equal to a determination threshold value.

(A-4)

The anomaly detection method of (A-2), wherein in the correlation model generation process, the correlation model is generated by inputting the data at the normal time as learning data, and

in the first detection process, a range in which a distribution of the error between the input value and the output value of the correlation model based on the data at the normal time other than the learning data includes a constant rate is used as a determination threshold value.

(A-5)

The anomaly detection method of (A-1), wherein

when an anomaly is determined in the first detection process, the determination result is output, and when an anomaly is not determined, the second detection process is performed.

(A-6)

The anomaly detection method of (A-1), wherein

in the anomaly degree extraction process, a sum of differences between predicted values and measured values of the output nodes extracted in the correlation model generation process is extracted.

(A-7)

The anomaly detection method of (A-6), wherein

in the anomaly degree extraction process, a weight component is assigned to a difference between the predicted value and the measured value, based on a magnitude or importance of the difference.

(A-8)

The anomaly detection method of (A-6), wherein

the anomaly degree generated in the anomaly degree extraction process is a sum of differences between the predicted values and the measured values.

(A-9)

The anomaly detection method of (A-8), wherein

the time series model generation is performed with time series data obtained by smoothing time series data of the anomaly degree in the smoothing process.

(A-10)

The anomaly detection method of (A-1), wherein

the machine learning is performed by using the time series data of the anomaly degree including time variation as input data.

(A-11)

The anomaly detection method of (A-10), wherein

in the time series model generation process, the time series model is generated with Long-Short Term Memory (LSTM), and

in the second detection process, an error between an input value and an output value of the time series model is calculated as a divergence degree from the normal status, and an anomaly is determined when the divergence degree is larger than or equal to a determination threshold value.

(A-12)

The anomaly detection method of (A-11), wherein

in the anomaly degree extraction process, an anomaly degree extracted based on data at normal time is output,

in the time series model generation process, the time series model is generated based on the anomaly degree extracted based on the data at the normal time, and

in the second detection process, the determination threshold value is determined for a rate of distribution, in the distribution of an error between the input value and the output value of the time series model based on data at the normal time unused when the time series model is generated.

(A-13)

The anomaly detection method of (A-11), wherein

in the time series model generation process, the time series model is generated using Recurrent Neural

Network (RNN) instead of LSTM.

(A-14)

The anomaly detection method of (A-11), wherein

in the time series model generation process, the time series model is generated using Gated Recurrent Unit (GRU) instead of LSTM.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. A plurality of embodiments may be combined with each other, and examples structured by these combinations are within the scope of the embodiments. In addition, the names and terms used are not limited, and the other expressions are included in the scope of the embodiments as long as they means substantially the same matters. Furthermore, the constituent elements in claims are in the category of the embodiments even if the components are expressed separately, even if the components are expressed in association with each other or even if the components are expressed in combination with each other.

To further clarify explanations, the width, thickness, shape and the like of each unit may be schematically shown in the drawings compared with the actual aspects, in the drawings for illustrating the embodiments. In the functional block diagrams of the drawings, the constituent elements of the functions necessary for the descriptions are represented by the blocks, and descriptions of the constituent elements of general functions may be omitted. In addition, the blocks indicative of the functions are conceptual in function, and do not need to be physically constituted as shown in the drawings. For example, concrete forms of distribution and integration of the blocks of each function are not limited to the forms in the drawings. The forms are distributed and integrated functionally or physically in accordance with use conditions in the blocks of each function. In addition, in the functional block diagrams of the drawings, data or signals may be exchanged between the blocks which are not linked or in a direction which is not represented by an arrow between linked blocks.

The processes shown in the flowcharts of the drawings may be implemented by hardware (IC chips and the like), software (programs and the like), or combinations of hardware and software. Even when a claim is expressed as a control logic, or as a program including an instruction for executing a computer, or as a computer-readable recording medium describing the instruction, the device of the embodiments is applied.

In addition, the names and terms used are not limited, and the other expressions are included in the scope of the embodiments as long as they means substantially the same matters.

What is claimed is:

1. An anomaly detection device comprising:
a data input unit acquiring system data output from at least one anomaly detection target;
a data processing unit generating time series monitoring data, based on the system data;
a first predicted value calculation unit calculating a first model predicted value from input monitoring data and a correlation model obtained by first machine learning using the monitoring data;
an anomaly degree calculation unit calculating an anomaly degree indicative of a magnitude of an error between a value of the input monitoring data and the first model predicted value and outputting anomaly degree time series data which is time series data;
a second predicted value calculation unit calculating a second model predicted value to the anomaly degree from a time series model obtained by second machine learning different from the first machine learning, using the anomaly degree time series data;
a determination value calculation unit calculating a divergence degree indicative of a magnitude of an error between the anomaly degree and the second model predicted value to the anomaly degree; and
an anomaly determination unit determining whether an anomaly occurs at the anomaly detection target or not, based on one of the anomaly degree and the divergence degree.

2. The anomaly detection device of claim 1, wherein
the first machine learning uses Auto Encoder.

3. The anomaly detection device of claim 2, wherein
the first machine learning generates the correlation model, using first monitoring data obtained from first system data acquired in a period in which an anomaly is not detected at the anomaly detection target.

4. The anomaly detection device of claim 2, wherein
the anomaly degree calculation unit weights each of reconstruction errors that are squared errors between values of the input monitoring data and the first model predicted values, based on a priority or a magnitude of the reconstruction error, and calculates a sum of the weighted reconstruction errors as the anomaly degree.

5. The anomaly detection device of claim 4, further comprising:
a first threshold value determination unit,
wherein
the anomaly degree calculation unit calculates a first anomaly degree with second monitoring data not including first monitoring data obtained from the first system data,
the first threshold value determination unit stores a value of the first anomaly degree, generates a probability distribution of the first anomaly degree, and determines a first threshold value by a cumulative probability in the probability distribution of the first anomaly degree; and
after the first threshold value is determined, the anomaly determination unit obtains third monitoring data from second system data acquired from the anomaly detection target at operation, and determines whether an anomaly occurs at the anomaly detection target or not, using the second anomaly degree and the first threshold value.

6. The anomaly detection device of claim 5, wherein
the anomaly determination unit determines that an anomaly occurs at the anomaly detection target when the second anomaly degree exceeds the first threshold value.

7. The anomaly detection device of claim 5, wherein
the first threshold value determination unit generates a probability distribution of the second anomaly degree with a value of the second anomaly degree, and
the anomaly determination unit determines that an anomaly occurs at the anomaly detection target when a rate of the second anomaly degree larger than or equal to the first threshold value exceeds a predetermined first rate threshold value in the probability distribution of the second anomaly degree.

8. The anomaly detection unit of claim 5, wherein
the time series model is generated by the second machine learning using the first anomaly degree after the first threshold value determination unit determines the first threshold value.

9. The anomaly detection device of claim 8, further comprising:
a second threshold value determination unit,
wherein
the second threshold value determination unit stores a value of the first divergence degree from the first anomaly degree, generates a probability distribution of the first divergence degree, and determines a second threshold value by a cumulative probability in the probability distribution of the first divergence degree; and
after the second threshold value determination unit determines the second threshold value, the anomaly determination unit determines whether an anomaly occurs at the anomaly detection target or not, using the second threshold value and a value of a second divergence degree calculated with the second anomaly degree.

10. The anomaly detection device of claim 9, wherein
the anomaly determination unit determines that an anomaly occurs at the anomaly detection target when the value of the second divergence degree is larger than the second threshold value.

11. The anomaly detection device of claim 9, wherein
the anomaly determination unit generates a probability distribution of the second divergence degree with a value of the second divergence degree, and determines that an anomaly occurs at the anomaly detection target when a rate of the second divergence degree larger than or equal to the second threshold value exceeds a predetermined second rate threshold value in the probability distribution of the second divergence degree.

12. The anomaly detection device of claim 10, wherein
the anomaly determination unit performs determination with the divergence degree when determining that an anomaly does not occur at the anomaly detection target with the second anomaly degree and the first threshold value.

13. The anomaly detection device of claim 8, further comprising:
a smoothing unit smoothing time series data of the anomaly degree output from the anomaly degree calculation unit,
wherein
the time series data of the anomaly degree smoothed by the smoothing unit is input to the determination value calculation unit.

14. The anomaly detection device of claim 1, wherein
the second machine learning uses Long-Short Term Memory.

15. The anomaly detection device of claim 1, wherein
the second machine learning uses Recurrent Neural Network.

16. The anomaly detection device of claim 1, wherein
the second machine learning uses Gated Recurrent Unit.

17. An anomaly detection method comprising:
acquiring system data output from at least one anomaly detection target;
generating time series monitoring data, based on the system data;
calculating a first model predicted value from input monitoring data and a correlation model obtained by first machine learning using the monitoring data;
calculating an anomaly degree indicative of a magnitude of an error between a value of the input monitoring data and the first model predicted value;
outputting anomaly degree time series data which is time series data;
calculating a second model predicted value to the anomaly degree from a time series model obtained by second machine learning different from the first machine learning, using the anomaly degree time series data;
calculating a divergence degree indicative of a magnitude of an error between the anomaly degree and the second model predicted value to the anomaly degree; and
determining whether an anomaly occurs at the anomaly detection target or not, based on one of the anomaly degree and the divergence degree.

18. A program of causing a computer to determine whether an anomaly occurs at an anomaly detection target or not, the program comprising the steps of:
acquiring system data output from at least one anomaly detection target;
generating time series monitoring data, based on the system data;
calculating a first model predicted value from input monitoring data and a correlation model obtained by first machine learning using the monitoring data;
calculating an anomaly degree indicative of a magnitude of an error between a value of the input monitoring data and the first model predicted value;
outputting anomaly degree time series data which is time series data;
calculating a second model predicted value to the anomaly degree from a time series model obtained by second machine learning different from the first machine learning, using the anomaly degree time series data;
calculating a divergence degree indicative of a magnitude of an error between the anomaly degree and the second model predicted value to the anomaly degree; and
determining whether an anomaly occurs at the anomaly detection target or not, based on one of the anomaly degree and the divergence degree.
